(19) United States
(12) Patent Application Publication
(10) Pub. No.: US 2026/0030834 A1
(43) Pub. Date: Jan. 29, 2026

(54) ADVANCED RENDERING OPTIMIZATION TECHNIQUES FOR 3D GRAPHICS

(71) Applicant: Unity Technologies SF, San Francisco, CA (US)

(72) Inventors: Alexander Suvorov, Berlin (DE); Ralph Leonard Hauwert, Charlottenlund (DK)

(21) Appl. No.: 19/278,600

(22) Filed: Jul. 23, 2025

Related U.S. Application Data
(60) Provisional application No. 63/674,751, filed on Jul. 23, 2024.

(51) Int. Cl. G06T 15/20

(52) U.S. Cl. CPC G06T 15/20; G06T 2210/62

(57) ABSTRACT

A method of implementing directional opacity handling in Gaussian splats is disclosed. An approximate representation of a scene is received. 3D geometry data is generated. The 3D geometry data includes an approximate position and normal of each splat in a set of splats in the scene. Directional opacity values are calculated for the set of splats based on an application of a machine-learning model trained to optimize values of splat parameters, the values including the directional opacity values. The calculated directional opacity values are applied to the set of splats to enhance processing of the set of splats.

### CROSS-REFERENCE TO RELATED APPLICATIONS

This application claims the benefit of U.S. Provisional Application No. 63/674,751, filed Jul. 23, 2024, which is incorporated by reference herein in its entirety.

### TECHNICAL FIELD

The subject matter herein generally relates to computer graphics rendering technologies, and, in one specific example, to methods and systems for optimizing color space transformations and/or visibility parameters in rendering applications.

### BACKGROUND

The field of computer graphics involves the generation and manipulation of visual content using computational methods. Within this field, rendering may include a process that converts three-dimensional models into two-dimensional images. This process may be used in various applications, including video games, virtual reality, and simulations, where realistic visual representations are valued.

Some traditional rendering techniques may rely on an RGB color model, which represents colors through combinations of red, green, and blue components. While effective for many applications, this approach can lead to inefficiencies, particularly in terms of data storage and processing requirements. These inefficiencies may be pronounced in scenarios requiring high fidelity and detailed visual outputs, where precision and optimization of data are paramount.

Moreover, rendering techniques must handle the visibility of objects from different viewing angles, especially when simulating complex optical properties such as reflections and transparency. Traditional methods may struggle with these challenges, leading to increased computational costs or compromised visual quality.

As the demand for more realistic and computationally efficient rendering solutions grows, there is a continuous need for innovations in rendering technologies that address these inefficiencies.

### BRIEF DESCRIPTION OF THE DRAWINGS

Features and advantages of example embodiments of the present disclosure will become apparent from the following detailed description, taken in combination with the appended drawings, in which:

FIG. 1 is a block diagram depicting example modules of a system for enhancing a rendering process;

FIG. 2 is flowchart depicting an example method of rendering one or more images using optimized per-splat YUV values;

FIG. 3 is flowchart depicting an example method of training a model to generate optimized per-splat YUV values from per-pixel YUV values;

FIG. 4 is flowchart depicting an example method of implementing splat property sharing in rendering;

FIG. 5 is a block diagram illustrating an example software architecture, which may be used in conjunction with various hardware architectures described herein, in accordance with one or more example embodiments; and

FIG. 6 is a block diagram illustrating components of a machine, according to some example embodiments, configured to read instructions from a machine-readable medium (e.g., a machine-readable storage medium) and perform any one or more of the methodologies discussed herein, in accordance with one or more example embodiments.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the disclosed subject matter. It will be evident, however, to those skilled in the art, that various embodiments of the disclosed subject matter may be practiced without these specific details.

In example embodiments, systems, methods, and computer-readable media for implementing graphical rendering are disclosed. In example embodiments, a technique called Gaussian Splatting is adapted for reconstructing and rendering real-world or synthetic objects using a specialized rendering technique that leverages hardware efficiently. In the context of this application, the term “Gaussian splat” is used broadly to encompass any type of splatting technique or methodology for rendering, reconstruction, or visualization purposes, and is not intended to be limited solely to splats based on a Gaussian distribution. Rather, the term may refer to a variety of splatting approaches, including but not limited to elliptical splats, which adapt anisotropically to surface curvature; disk splats, characterized by uniform density with sharp edges; box splats, employing square-shaped uniform regions; radial basis function (RBF) splats, such as multiquadric or inverse multiquadric functions; power-law splats, which decay polynomially with distance; exponential splats, featuring rapid falloff; spline-based splats for smooth interpolation; and adaptive splats, which dynamically adjust their properties based on local geometric or density characteristics. These diverse splatting techniques are considered interchangeable within the scope of this application, provided they fulfill the intended purpose of representing or approximating point-based data for rendering, reconstruction, or related computational tasks.

In example embodiments, a training algorithm incorporates artificial intelligence (AI) and/or machine learning concepts to reconstruct scenes by fitting them through neural network technology. This involves significant improvements in how machine-learning models are constructed (e.g., trained) and deployed, particularly in terms of efficiency and error reduction.

In example embodiments, color domains are switched. For example, switching from RGB to YUV color space is performed, which may optimize the storage and/or processing of color data. For example, this switch may allow for more efficient handling of luminance and chrominance, leading to better compression and/or reduced data size.

In example embodiments, directional opacity for splats is implemented, wherein the opacity value for a splat is dependent on the viewing angle. For example, directional opacity may be handled using spherical harmonics, which allows splats to hide or reveal themselves based on a viewing angle. This technique may enhance the rendering of objects by allowing more precise control over how they appear from different perspectives. Methods other than spherical harmonics may be used to capture, store and/or process the directional opacity data for a splat, including wavelets, phase functions, fourier based functions, hemispherical functions, radial basis functions (RBFs), and more.

In example embodiments, the disclosed YUV color space implementations include a shift from RGB to YUV that may provide for better data compression and efficiency in rendering processes. Traditional RGB color space used in rendering processes often leads to inefficiencies in data storage and processing, especially when dealing with variations in brightness rather than color. This inefficiency becomes pronounced in high-fidelity rendering where precision and data compression are crucial. The disclosed systems and methods provide a technological solution that includes switching from RGB to YUV color space. This switch focuses on optimizing the handling of luminance (brightness) and chrominance (color information), which are more relevant to the perceived changes in some scenes. By doing so, the data size needed for rendering may be reduced, compression rates may be improved, and/or high visual fidelity may be maintained (e.g., under varying lighting conditions).

In example embodiments, directional opacity handling in splats is implemented. The disclosed systems and methods may be used to manage the visibility of splats based on the viewer's angle. In example embodiments, spherical harmonics are used to achieve this. In existing rendering techniques, managing how objects appear from different angles can be challenging, especially when trying to mimic complex phenomena like reflections or transparency. For example, traditional methods may not effectively handle the visibility changes required when an object is viewed from different perspectives, leading to unrealistic renderings or high computational costs.

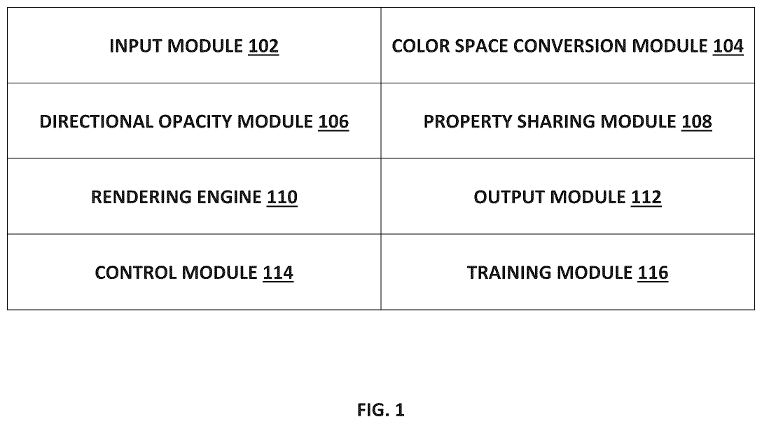

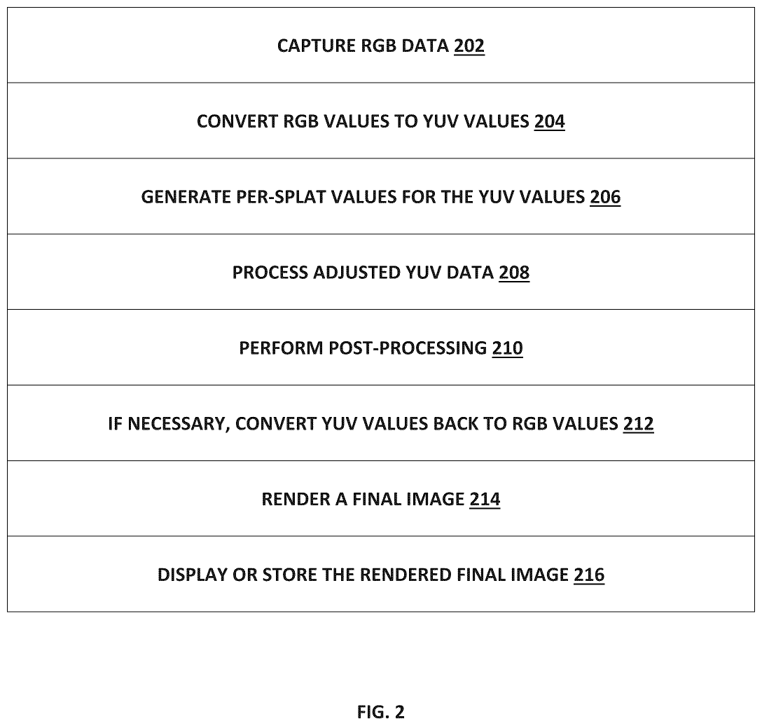

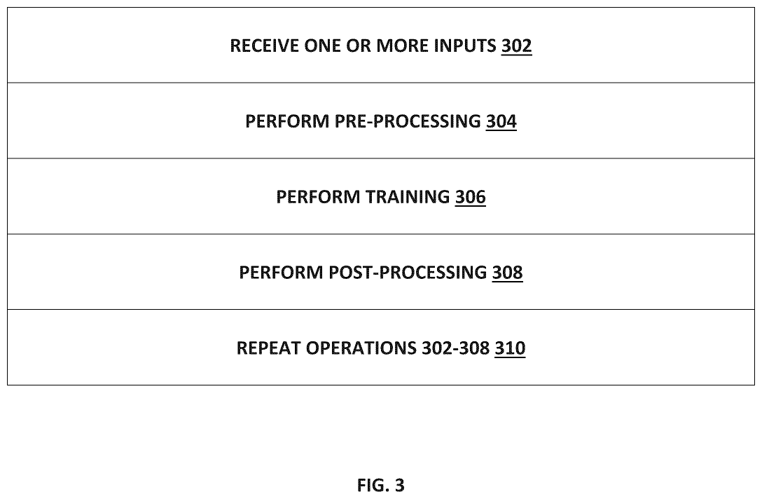

The disclosed systems and methods provide a technological solution that includes introducing directional opacity for splats, where the visibility of each splat can be controlled based on the viewing angle. Spherical harmonics may be used to modulate the opacity, allowing splats to effectively “hide” or “appear” depending on the viewer's perspective (even when hidden, a splat may still be rendered, just with almost zero visibility). Directional opacity allows the rendered visibility of splats to gradually change with angle, allowing for splats to gradually hide or gradually appear when viewing direction is changed. This technique may enhance the realism of rendered objects, particularly in simulating materials with complex reflective and transparent properties (e.g., semi-transparent materials, without significantly increasing computational demands). This technique may enhance the realism of rendered objects by improving the quality of reflections, reducing reflection artifacts, reducing noisiness of rendered surfaces, and allowing better representation of gradient changes in color. This technique can also help enhance realism with respect to the rendering of complex objects which have internal cavities and/or semi-transparent surfaces and wherein the accurate rendering of such internal cavities or across the semi-transparent surface is difficult without directional opacity for splats. For example, when rendering for a viewer within an internal cavity using splats, the directional opacity from this technique can help hide “ghost” reflection artifacts that erroneously appear within the cavity of objects that are outside of the cavity but have a reflection on the wall of the cavity. Similarly, when rendering across a semi-transparent surface using splats (or any surface that may generate a reflection), the directional opacity from this technique can help hide “ghost” reflection artifacts that erroneously appear to a viewer on an opposite side of the semi-transparent (or reflective) surface of objects that are across the semi-transparent surface but have a reflection on the surface (e.g., hiding a ghost artifact of a car's sideview mirror from appearing within the car based on there being an external reflection of the mirror in the car's side window; i.e., outside the car both the sideview mirror and its reflection in the side window should be visible, whereas when rendering inside the car only the sideview mirror should be visible and the external reflected version should not. The above example is symmetric for objects inside the car, hiding ‘ghost’ artifacts from being seen by a viewer outside the car). The hiding of ‘ghost’ reflection artifacts is possible using directional opacity since splats that represent the ‘ghost’ reflection artifacts of the reflection of an object are assigned directional opacity values (as described herein, and particularly with respect to FIG. 1, FIG. 2, and FIG. 3) such that the reflection of the object only appears on the correct side of the semi-transparent or reflective surface (e.g., wherein the directional opacity values make the object visible) and does not appear when viewed from the incorrect side of the surface (e.g., wherein the directional opacity values make the object invisible).

In example embodiments, splat property sharing is implemented in rendering. In example embodiments, sharing properties across similar splats may reduce data redundancy, which, in turn, may lead to more efficient data handling and/or lower storage requirements. High entropy in data representation may be an issue in rendering, where each point (splat) in a rendered scene might be treated independently, leading to large data sizes and inefficiencies in data storage and processing. This problem may be particularly acute in detailed and high-quality renderings where consistency across similar objects or surfaces is required.

The disclosed systems and methods provide a technological solution that includes sharing properties among splats that are in close proximity and/or similar in terms of their characteristics. By enforcing coherence among the properties of neighboring splats, an algorithm can reduce the overall data variability (entropy) and enhance compressibility. This approach not only aims to decrease the data required for rendering but also improves the consistency and realism of the appearance of one or more properties (e.g., material properties) across different parts of the object.

The disclosed systems and methods represent significant advancements in rendering technology, with potential applications in gaming, real-time 3D rendering, and/or other fields that require high-fidelity visual representations. The disclosed systems and methods provide solutions for specific limitations in the prior art, including by introducing innovative techniques that leverage modern computational methods and/or insights from related fields like machine learning and data compression. These advancements are directed towards creating more efficient, realistic, and/or scalable rendering technologies, which are crucial for various applications, including gaming, virtual reality, and/or real-time simulations.

FIG. 1 is a block diagram depicting example modules of a system for enhancing a rendering process.

An input module 102 is configured to handle the input of one or more images or scenes, from which initial parameters corresponding to one or more objects may be estimated, such as geometry, texture, and/or material properties.

In example embodiments, one or more 2D images are taken from different camera positions (e.g., from real-world photos taken by a client device or rendered images in a 3D editor). In example embodiments, the input may be 3D image or object data.

In example embodiments, the input module 102 includes a geometry loader that is configured to load 3D models and/or their associated data, such as vertex positions and normals; a texture loader configured to import texture maps and/or associated data such as diffuse, specular, and normal maps; and/or a material loader configured to retrieve initial material properties for each of one or more splats, including color and/or one or more physical properties like reflectivity.

A color space conversion module 104 is configured to perform color domain switching, such as by converting RGB color data to YUV color space and/or vice versa. The color space conversion module may include an RGB to YUV converter that is configured to transform RGB values to YUV (e.g., using predefined transformation matrices), optimizing color data for processing and storage; and/or a YUV to RGB converter that is configured to convert YUV values back to RGB (e.g., for compatibility with devices and/or standards that require RGB data).

A directional opacity module 106 is configured to modify opacity of splats based on the viewing angle (e.g., using spherical harmonics). The directional opacity module may include an opacity calculator that is configured to compute initial opacity values for each splat (e.g., based on one or more properties and/or viewing conditions); and/or a spherical harmonics processor that is configured to apply spherical harmonics (e.g., to adjust the opacity of splats dynamically, depending on the angle of incidence from the viewer's perspective).

A property sharing module 108 is configured to implement property sharing among splats (e.g., to reduce data redundancy and enhance rendering consistency). The property sharing module 108 may include a clustering module that is configured to segment splats into groups (e.g., based on similarity in material properties) and/or splat properties (e.g., using one or more clustering algorithms); and/or a shared property calculator that is configured to determine shared parameters for each group and/or apply such parameters to the splats within the group.

A rendering engine 110 is configured to integrate processed data to render a final image. The rendering engine 110 may include a shader manager that is configured to manage shaders that apply one or more lighting, texture, and/or material effects based on the processed data; a render pipeline that is configured to orchestrate a rendering process (e.g., by combining geometry, modified textures, and/or material properties) to produce a final output.

An output module 112 is configured to cause an output of the rendered image (e.g., to a display or a storage system). The output module 112 may include a display interface configured to manage or cause a display of one or more rendered images on one or more devices; and/or a storage manager that is configured to handle or cause a saving of one or more rendered images (e.g., to files) or transmission over networks.

A control and/or optimization module 114 may be configured to oversee a rendering process, ensuring efficiency and quality. The control and optimization module 114 may include a performance optimizer configured to dynamically adjust one or more processing parameters (e.g., to optimize rendering speed and quality); an error handler configured to manage errors and/or ensure robust operation throughout the rendering process. In example embodiments, the control and/or optimization module 114 may be integrated within the rendering engine 110.

In example embodiments, in a preprocessing step, input images are processed in order to estimate camera positions, rotations, and/or other characteristics (e.g., Field of View, etc.) of one or more cameras which generated the input images. An initial approximate configuration of splats representing the scene are generated.

In example embodiments, this can be done using external SfM (surface from motion) or photogrammetry software, a custom solution, or, if the initial images were rendered images as opposed to photographs of the real world, this information can be partially exported from a 3D rendering engine (e.g., the Unity™ game engine) in a form of initial point cloud and camera parameters.

Providing estimates in this way improves the overall output rendering quality of the method. In example embodiments, estimated splat parameters may not need a high level of accuracy; for example, the preprocessing step may be completely skipped, in which case the initial splat parameters can be filled with random values. However, providing random values for the initial splat parameters may lessen the rendering quality.

In example embodiments, in a training step (e.g., as described below, and as described with respect to the training module 116 and with respect to the perform training 306 process in FIG. 3), the initially provided approximate splat parameters are refined (along with adding more splats if necessary), in such a way that rendered output using the splat parameter better match the input images.

Partial information about approximate splat configuration coming from the preprocessing step is taken and missing parts are filled in with default values or based on appropriate criteria (e.g., preprocessing may generate only positions and base colors of the approximate splats, while the rotation/scaling/opacity spherical harmonics/higher bands of color spherical harmonics are filled with default initial values).

Input of the training step may include a set of input images, along with their corresponding camera positions and camera parameters (either estimated or captured in the preprocessing step). In example embodiments, additional information, including 3D geometrical information, may be provided to the training step to improve the output of the training step.

In example embodiments, RGB-to-YUV conversion may happen in the beginning of the training, but it can be also performed in a preprocessing step. The output of the training may include the refined configuration of the splats with properly trained per-splat parameters, including, for example, one or more of position, rotation, scaling, spherical harmonics coefficients for YUV, and spherical harmonics coefficients for opacity.

In example embodiments, during the training, one or more parameters of the one or more splats are optimized at the same time as they all contribute to a cumulative loss function which evaluates how well the current configuration of the splats (when used to render output images) approximates the scene views provided in a form of input images. With each iteration the system adjusts the parameters of all the splats to reduce the loss value. In example embodiments the specific loss function may depend on the problem being solved, and may include mean squared error (MSE), L1 loss (mean absolute error), structural similarity index measure (SSIM), peak signal-to-noise ratio (PSNR), and any combination therein. Other loss functions may be used.

In example embodiments, in a post-processing step, trained per-splat parameters are adjusted in order to optimize one or more of distribution size, loading time, or other criteria.

In example embodiments, post-processing includes one or more of quantization of the splat parameters, filtering the splats based on the contribution, or any other processing that would optimize compression ratio or speed up the splat loading in the renderer. The post processing step may take the refined splats as the input, and output the adjusted set of splats (e.g., appropriately encoded and compressed) ready for distribution. Post-processing may be separated from the training because the criteria for adjustment might depend on the target platform; therefore, the training step can output general data suitable for all platforms (or consequent training), while post-processing adjusts the emitted data to better fit a specific platform (e.g., including specific web based platforms, console based platforms, mobile phone based platforms, etc.) (e.g., in a similar way as it happens with game builds generated by a game engine, where post-processing of the splats is somewhat equivalent to packaging the game for a specific gaming platform).

In example embodiments, a rendering step includes loading the package generated by post-processing on the client device and renders the scene on the screen.

In example embodiments, optional YUV->RGB backwards conversion can happen during the post-processing step.

RGB->YUV conversion of the input images may happen in the preprocessing step, but can also be performed in a training step. Generation of the YUV per-splat parameters can happen in preprocessing or in the training step.

Generation and training of the directional opacity parameters (e.g., coefficients of spherical harmonics) may happen in the training step (this may not happen in the preprocessing step because, during preprocessing, there may not be any geometry yet available to estimate opacity.

Sharing of properties, such as material properties, can happen in preprocessing, training or post-processing, or spread between all these steps (which is the most likely scenario, because property segmentation information can be also treated as additional splat parameters).

In example embodiments, preprocessing, training, and/or post-processing steps can be grouped together and called “training.”

In example embodiments, all the steps can be grouped together and called a “rendering method” (e.g., a general scheme for how to render something may include the preparation work that helps this to happen, in addition to the steps that specifically generate the actual “rendering” on the screen).

A training module 116 is configured to facilitate the training of one or more models (e.g., including modification of splat parameters including YUV values, directional opacity values, positions, rotations, normals, spherical harmonic parameters or other parameters used within a rendering algorithm) for optimizing the rendering process. For example, this module may be configured to perform processing and transforming of input data into a format that is conducive to efficient rendering. The training module 116 may apply one or more machine learning techniques to refine one or more parameters used in the rendering algorithms (e.g., focusing on the conversion of per-pixel YUV values to per-splat YUV values using spherical harmonics).

The training module 116 may include a data preprocessing sub-module that prepares input image data by converting RGB values to YUV values and normalizing these values as needed. This preprocessing step may ensure that the data fed into the training algorithms is in the optimal state for processing, which enhances the accuracy and efficiency of the training process.

Following data preparation, the training module 116 may employ one or more neural networks or other suitable machine learning models to train model parameters and/or one or more processes or modules described with respect to FIG. 1. This may involve adjusting spherical harmonics coefficients to minimize the loss function, which measures the discrepancy between the rendered outputs and the actual appearances of the scenes or objects (e.g., minimizing discrepancies that arise from comparing rendered outputs to the initial input images, or other object data, provided to the training module 116). The optimization process may iteratively adjust the parameters to find the best possible configuration that represents the scene with high fidelity and minimal rendering errors.

Additionally, the training module 116 may be configured to handle various training scenarios, including supervised, unsupervised, and semi-supervised learning models, depending on the nature of the input data and the specific requirements of the rendering process. This flexibility allows the module to adapt to different rendering challenges and data types, enhancing its utility in diverse applications.

Once the training is complete, the training module 116 may output optimized per-splat YUV values (e.g., YUV coefficients), directional opacity values (e.g., directional opacity coefficients), positions, rotations, normals, or other parameters. These optimized values may then be stored in a format that can be directly used by the rendering engine 110, or further processed by other modules like the property sharing module 108 or the directional opacity module 106, depending on the configuration of the system.

In example embodiments, splat parameters may include one or more of 3D position; 3D rotation (e.g., quaternion); 3D scaling (e.g., up to 3 axes); Y, U, V channels, each represented in a form of coefficients (e.g., using spherical harmonics) so that the splat color may depend on the viewing direction (in example embodiments, the degree of spherical harmonics can be different for different channels (e.g., normally for U and V the degree is lower)); and/or opacity (e.g., representing in a form of coefficients (e.g., using spherical harmonics) so that the opacity may depend on the viewing direction).

The integration of the training module 116 into the rendering system architecture allows the system to produce visually accurate and computationally efficient renderings. By automating the optimization of one or more rendering parameters, the training module 116 may ensure that the rendering engine operates at peak efficiency, producing high-quality visual outputs that are true to the source material (e.g., reproducing an object or scene that was provided (e.g., via input images or other data) to the input module 102).

In example embodiments, the system includes dynamic adjustment capabilities that, for example, allow one or more real-time adjustments in response to one or more changes in scene conditions (e.g., changes in lighting) and/or user inputs.

In example embodiments, the system includes hardware acceleration support that, for example, integrates with GPU and/or other hardware accelerators to improve performance of computationally intensive tasks like spherical harmonics processing and/or property clustering.

Thus, the example architecture provides a comprehensive framework for implementing advanced rendering techniques that enhance visual quality, reduce computational load, and/or optimize data usage.

FIG. 2 is flowchart depicting an example method of rendering one or more images using optimized per-splat YUV values. In example embodiments, this rendering method, or parts therein may be used as part of a splat parameter training method such as that described with respect to FIG. 3.

At operation 202 RGB data may be captured (e.g., for a scene or an object that is to be rendered). In example embodiments, this data may be composed of red, green, and blue components for each pixel or rendering element, known as splats in some rendering techniques. The data can be sourced from digital assets or real-time inputs in a graphics application.

At operation 204, the RGB values may be converted to YUV values for each pixel (e.g., using one or more transformation equations). In example embodiments, this conversion involves linear transformations where the RGB values are multiplied by a predefined matrix to derive the YUV values. The Y component captures the luminance, which is the brightness level, while U and V components store chrominance information, representing color deviations from grey.

At operation 206, one or more trained algorithms may be applied to the per-pixel YUV values to generate per-splat YUV values. In example embodiments, the one or more algorithms applied to generate the per-splat YUV values may be trained using an application of spherical harmonics, as described in more detail with respect to FIG. 3. In example embodiments, the generation of per-splat YUV values provides one or more technical advantages related to rendering efficiency, reducing data overhead, improving visual quality, and/or enabling more sophisticated graphical effects in 3D rendering applications.

For example, per-splat values may allow for more efficient rendering. By aggregating pixel data into splats, the rendering system can manage fewer data points, which is computationally less intensive than processing every single pixel. This may be especially beneficial in real-time rendering scenarios where computational resources and time are limited.

As another example, converting to per-splat values may aid in data compression. Because splats represent aggregated information of multiple pixels, they can reduce the overall data size needed to describe a scene. This may be useful for applications like virtual reality and gaming, where large amounts of data need to be processed and transmitted efficiently.

As another example, per-splat values may facilitate the implementation of advanced visual effects. Splats can be manipulated to achieve effects such as blurring, shading, and reflections more effectively than per-pixel operations. This is because splats provide a higher level abstraction of the scene's geometry and optical properties, allowing for more complex interactions with light and shadow.

As another example, using per-splat values may enhance directional and/or spatial coherence in the rendering process. Splats can be oriented and/or scaled to align with the 3D geometry of the scene, maintaining consistency in appearance from different viewing angles. This is less feasible with per-pixel values, which lack this level of geometric and directional context.

As another example, the transition to per-splat values may allow for the optimization of visual quality through techniques like spherical harmonics for color and opacity representation. This mathematical framework may enable the splats to more accurately represent variations in color and transparency based on the viewing direction, leading to more realistic and dynamic images.

As another example, by dealing with fewer, more meaningful data aggregates (splats), complex computations related to lighting, shading, and/or color adjustments may become more manageable and can be executed more efficiently.

Additionally, the use of YUV color space instead of RGB color space in the rendering process may provide one or more technical advantages that enhance the efficiency and/or effectiveness of the rendering technology. One of the benefits of employing YUV values is related to the way human vision perceives color and brightness. The YUV color model separates luminance (Y), which is the brightness or grayscale information, from chrominance (U and V), which represents color information. This separation aligns more closely with human visual perception, where the eye is more sensitive to variations in brightness than to changes in color.

By focusing on luminance separately from chrominance, the YUV model allows for more efficient data compression strategies. Since the luminance channel (Y) carries the details that are most important for perceptual quality, it can be preserved with higher fidelity. In contrast, the chrominance channels (U and V) can be compressed more aggressively without significantly affecting the perceived quality of the image. This approach not only reduces the amount of data that needs to be processed and stored but also enhances the speed of rendering operations, making it particularly advantageous for real-time applications.

Furthermore, the use of YUV color space facilitates more effective error reduction in the rendering process. By independently adjusting the Y, U, and V components, the algorithm can fine-tune the balance between brightness and color accuracy more effectively than with RGB values. This capability may be useful when dealing with complex scenes where lighting conditions vary significantly, as it allows for dynamic adjustments that can improve the overall visual coherence and realism of the rendered images.

Additionally, training algorithms (e.g., such as those used in the perform training 306 step as described with respect to FIG. 3) that operate in the YUV space can achieve faster convergence and potentially yield better results in terms of the final image quality. The distinct handling of luminance and chrominance allows the algorithms to prioritize the optimization of brightness details, which are more important to the visual quality, before fine-tuning the color aspects. This prioritization can lead to more efficient training cycles and quicker readiness of the rendering system for deployment.

In example embodiments, the representation of image data in YUV color space during the training phase (e.g., such as in the perform training 306 step as described with respect to FIG. 3) allows for a more nuanced control over how different aspects of the scene are prioritized and reconstructed.

For example, during the training phase (e.g., during the perform training 306 step as described with respect to FIG. 3), employing YUV values may facilitate a more targeted approach to optimizing the luminance (Y) and chrominance (U and V) components separately. This separation may be advantageous because it allows the training algorithm to prioritize luminance, which is more closely aligned with human visual sensitivity to brightness variations. By focusing on luminance, the training can achieve more accurate reconstructions of the scene's lighting dynamics, which are often more important to the perceived quality of the image than color accuracy.

Moreover, the use of YUV values in training may support a more efficient allocation of computational resources. Since chrominance components often require less precision compared to luminance, the training process can allocate fewer resources to U and V components without significantly impacting the overall visual quality. This efficiency may be useful for speeding up the training process and reducing computational costs, making the system more scalable and responsive to real-time rendering demands.

While advantages of using YUV values may be more pronounced during the training phase (e.g., such as during the perform training 306 step as described with respect to FIG. 3), there may also be subtle yet valuable impacts during the rendering phase. Although the final rendering output may require conversion back to RGB color space to match display standards, the intermediate processing in YUV space can still influence the final image quality. Adjustments made to YUV components during rendering, such as fine-tuning luminance for dynamic lighting conditions or adjusting chrominance for color balance, can result in a more refined visual output. These adjustments, while subtle, contribute to the overall realism and visual coherence of the rendered scenes.

Thus, the adoption of YUV color space over RGB in the rendering process may offer improvements in data compression, processing efficiency, and/or visual quality.

In example embodiments, the YUV parameters may be adjusted by the system (e.g., to optimize rendering based on one or more specific requirements or conditions). This adjustment of YUV parameters may be performed as part of the training process discussed with respect to FIG. 3). The output of this step is a set of splats with optimized YUV parameters, ready to be used in subsequent rendering processes. In example embodiments, these splats may be capable of dynamically adjusting their appearance based on a viewer's perspective, thanks to the directional information encoded in their spherical harmonics coefficients (e.g., as described herein with respect to directional opacity). The adjustment of YUV parameters may include the optimization of spherical harmonics coefficients for each splat. These coefficients determine how the splat's color and opacity will vary depending on the viewing direction. For example, the system may adjust the spherical harmonics coefficients to minimize the difference between the rendered splats and the actual scene (e.g., images of the actual scene), effectively reducing the overall rendering error.

This process may not only enhance the visual quality by ensuring that colors and shades change naturally with perspective but also contributes to the efficiency of the rendering process. By working with and adjusting the YUV parameters instead of RGB values at the splat level, the system may reduce the computational load, enabling faster processing and more dynamic interactions in real-time applications.

In example embodiments, the U and V components may be scaled to alter color saturation, adjusting Y to modify brightness or contrast, or applying filters to enhance visual quality. These adjustments may be dynamic (e.g., based on scene content or lighting conditions).

At operation 208, the adjusted YUV data may be processed according to the specific needs of the rendering algorithm. This may involve additional steps such as noise reduction, sharpening, or other forms of image processing that prepare the YUV data for final rendering. Techniques such as compression algorithms can also be applied here to optimize data handling and storage. In example embodiments, the processing of the adjusted YUV data may be part of a splat parameter training method such as that described with respect to FIG. 3.

The adjusted YUV values, which, in example embodiments, are now represented as spherical harmonics coefficients for each splat, may undergo further processing to fine-tune these coefficients for optimal rendering performance. This includes applying additional filters or transformations that can enhance visual quality, such as sharpening or smoothing filters, which refine the appearance of the splats when rendered in the final image.

In example embodiments, a cumulative loss function may be recalculated to evaluate the effectiveness of the current splat configuration in approximating the actual scene (e.g., during the perform training 306 operation described with respect to FIG. 3). The system may perform iterative adjustments to the spherical harmonics coefficients to minimize this loss, thereby enhancing the accuracy and realism of the rendered scene.

In example embodiments, to ensure efficient storage and processing, the YUV data may be further compressed (e.g., during the perform post-processing 308 operation described with respect to FIG. 3). Techniques such as quantization of the spherical harmonics coefficients can be employed to reduce the data size without significantly compromising the visual quality. This step may be useful for applications requiring real-time rendering where data bandwidth and processing speed are limited.

The processed data is then formatted and organized in a manner suitable for the rendering engine. This may include aligning the data structures with the rendering pipeline's requirements and/or ensuring that all data is in the correct format for seamless integration into the subsequent rendering steps.

The processed splat data, now optimized and/or compressed, forms the basis for a final rendering operation. Each splat's YUV values, adjusted for directional effects and viewing angles, may contribute to a dynamically rendered image that accurately represents the scene with high fidelity and realism.

At operation 210, one or more post-processing operations may be performed. In example embodiments, the post-processing operations may be part of a splat parameter training method such as that described with respect to FIG. 3. In example embodiments, the post-processing operations may focus on enhancing data compression, optimizing load times, and/or ensuring that the splats are rendered with the highest fidelity and efficiency.

One or more quantization algorithms may be applied (e.g., to reduce the data size of the splat parameters while maintaining essential visual details). Splats that have minimal visual contribution to the final scene may be filtered out to streamline the rendering process.

Segmentation of splats may be performed (e.g., based on their material properties and light responses). This segmentation may help in grouping splats with similar characteristics, which can be processed together to improve rendering efficiency and property consistency across the scene.

One or more final adjustments may be made to the splat parameters (e.g., to ensure they are in the optimal format for the rendering engine). This may include aligning data structures and/or ensuring all parameters are optimized for the best performance during rendering.

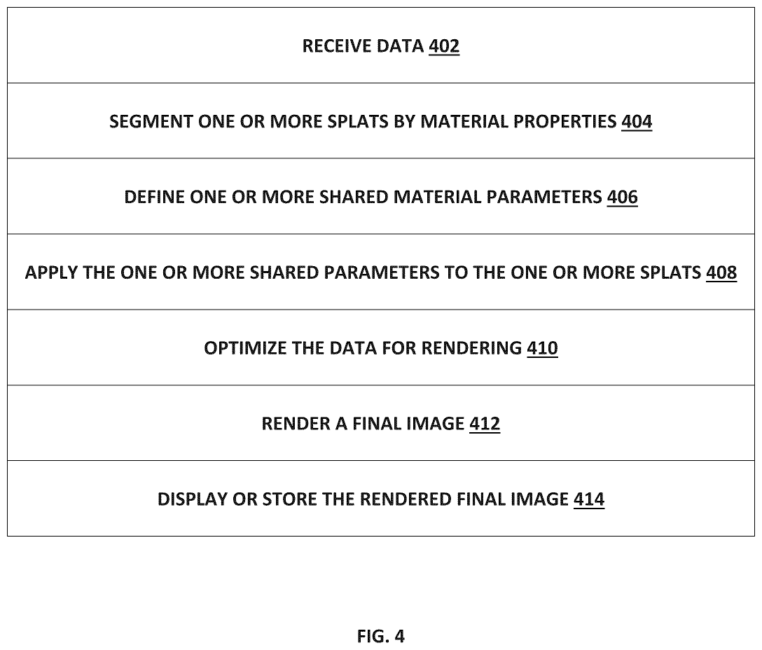

In example embodiments, the post-processing may include operations for implementing shared properties, as described with respect to FIG. 4.

The output from this post-processing may be a set of highly optimized splats, ready to be used in the rendering engine. This ensures that the rendering process is not only faster but also produces higher quality images due to the pre-optimized splat data.

At operation 212, in various scenarios (e.g., based on an output device or format requiring RGB data), the processed YUV data in the splats may be converted back to RGB in order to generate optimized RGB splats (e.g., using inverse transformation equations). Thus, devices and standards that do not support YUV natively may be supported with the use of these optimized RGB splats which were generated from the optimized YUV splats (alternatively, as described herein, at a subsequent step, fully rendered YUV images generated from optimized YUV splats may be converted to RGB once in the image format using YUV to RGB image conversion techniques).

Precise transformation matrices or algorithms that accurately map YUV values to RGB values may be applied, ensuring that the color integrity and quality are maintained in the conversion process. This may make it possible to preserve the visual enhancements achieved through the YUV optimization processes.

Because the YUV values may be represented as spherical harmonics, special considerations may be needed to convert these values back to RGB. Algorithms may be implemented and applied that can interpret the spherical harmonics data and accurately project these values into RGB space, considering the directional properties encoded within them.

The conversion process may be optimized to be computationally efficient, especially for real-time applications where rendering speed is critical. Various techniques, such as lookup tables or pre-computed conversion matrices that can speed up the transformation from YUV to RGB, may be employed.

One or more checks and/or balances may be implemented to ensure that the conversion process does not introduce artifacts or degrade the quality of the final image. This might include validation steps that compare the original RGB values (if available) with the converted values to ensure fidelity.

At operation 214, the YUV splat data (or the reconverted RGB splat data) may be used to render a final image (e.g., using a Gaussian splat rendering technique). The splat data may be used to represent one or more 3D models within a scene, integrating it with one or more other rendering effects, such as lighting, shadows, and/or reflections, to produce the final visual output.

The RGB data obtained from this conversion may then be used in a final rendering step, where it may be integrated with other rendering effects to produce the final visual output. This ensures that the rendered images are not only high in quality but also compatible with a wide range of display technologies that rely on RGB data.

At operation 216, the rendered image may be displayed or stored, as needed. For example, the image could be sent to a display screen, saved to a file, or transmitted over a network, or used within a splat training method as described with respect to FIG. 3.

In example embodiments, splats parameters are loaded onto a GPU on a client device. In example embodiments, operations related to training may be performed offline (e.g., not on the client side and/or not in real-time), and all other operations are performed online (e.g., on the client side and/or in real-time). In example embodiments, splats are rasterized per-pixel using the camera position, splat sort order, splat parameters, and/or splat view direction (and optionally scene light, such as in cases when the light information was previously extracted from splats).

In example embodiments, optimizations for computational efficiency and/or quality may be applied. Additionally, hardware acceleration (e.g., GPU processing) may be used where possible to enhance performance.

In example embodiments, one or more error handling and/or validation mechanisms may be implemented (e.g., to ensure data integrity and handle potential issues during the conversion and processing stages).

FIG. 3 is a flowchart depicting an example method of training a splat model (e.g., the model including splat parameters), wherein the method includes taking one or more images and/or estimates of per-pixel color values as inputs and provide one or more optimized images, per-splat YUV values, and/or one or more YUV coefficients as output (the outputs may also be converted to RGB values). The trained splat model may then be used for real-time rendering (or non real-time rendering), including Gaussian splat rendering and rendering as described with respect to FIG. 2 and FIG. 4.

At operation 302, one or more inputs are received. The input may include RGB data for captured images (e.g., for a scene or an object that is to be rendered). In example embodiments, this data may be composed of red, green, and blue components for each pixel. The data can be sourced from digital assets or real-time inputs in a graphics application. The input data may include images of a physical object or scene captured from a physical camera. The physical camera may output RGB images (e.g. from an RGB image sensor) and/or YUV images (e.g., from a conversion of RGB image sensor data)

In example embodiments, per-pixel YUV values are estimated and/or generated from input images (e.g., based on the input images being in RGB format). These images may be captured from various camera angles and positions, providing a comprehensive view of a scene. These images may be captured by a physical camera in a physical scene, and/or they may be captured by a virtual camera in a virtual 3D scene.

At operation 304, one or more pre-processing operations may be performed. For example, splats may be generated as basic data points in a 3D space. Each splat may be assigned preliminary values for position, rotation, scaling (e.g., size), opacity, and/or basic color attributes. At this stage, the color attributes may not yet be refined or represented using spherical harmonics. In example embodiments, based on input training images received (e.g., in operation 302) approximate initial splat positions can be estimated wherein those positions would have deterministic projections onto the input training images. The projection of a splat onto the training images allows for the determination of initial splat color for that splat based on the color information at the location of the projection on the training image. Training images may be in RGB format, so the reprojected RGB colors from the training images may be converted to YUV and then assigned to the splats.

In example embodiments geometry and/or texture data usable for constructing the scene's digital representation is loaded. The geometry data may comprise the positions and normals of splats, which are discrete data points strategically used to represent complex surface geometries within the rendering environment. Concurrently, texture data may be loaded, encompassing a range of attributes such as color, glossiness, and/or reflectivity, which are useful for achieving realistic textural effects on the rendered surfaces.

Once the foundational data is loaded and/or prepared, initial opacity values for each splat may be determined. These values may be determined based on one or more default settings and/or predefined criteria tailored to the specific rendering context. This may set a baseline visibility for each splat, which may later be refined (e.g., through directional adjustments) to accurately simulate real-world optical phenomena.

The rendering algorithm may capture or calculate viewing angles relative to each splat (e.g., based on the precise positioning and orientation of the camera within the scene). This information may be used for defining the perspective from which the splats are evaluated, ensuring that the rendering perspective aligns with the viewer's point of view.

In example embodiments, one or more directional opacity modulation techniques may be applied. For example, each splat's opacity may be dynamically adjusted using spherical harmonics, a mathematical framework that allows for the nuanced representation of how opacity changes with the viewing angle. This modulation may be used for simulating effects, such as transparency and/or translucency, under varying lighting conditions, enhancing the realism of the rendered image. In example embodiments, the opacity for all splats is initially unidirectional (i.e. spherical harmonics coefficients higher than order 0 are set to zero). During training, higher order coefficients of the opacity spherical harmonics of each splat begin to diverge from zero, making it more or less transparent from different viewing angles.

In example embodiments, the YUV color values for each splat may be transformed into a format amenable to spherical harmonics processing. This may involve decomposing the YUV values—where ‘Y’ represents luminance and ‘U’ and ‘V’ represent chrominance—into functions on a sphere. This transformation is designed to capture the intricate variations in color and brightness as perceived from different viewing directions, which may be important for scenes with complex lighting dynamics.

The spherical harmonics may be employed to calculate coefficients that effectively compress the color information of the splats. These coefficients may be optimized to capture essential variations in color and brightness due to changes in viewing angle and lighting, which may be useful in achieving high-fidelity renderings. The optimization of these coefficients may be a computationally intensive process that leverages advanced algorithms to minimize the loss function, thereby reducing discrepancies between the rendered outputs and the actual scene appearances (e.g., as performed in operation perform training 306).

In example embodiments, the directionally modulated opacity values may be combined with other rendering data, including the optimized YUV values and/or lighting information. This integration may be carefully managed to ensure coherence across different viewing angles, maintaining consistent visual output that faithfully represents the scene's real-world properties. The integration may involve adjustments to the properties and/or textural details of the splats, further refining the visual quality.

At operation 306, the system performs training (e.g., of the splat parameters).

In example embodiments, the training includes adjusting the spherical harmonics coefficients to minimize a loss function. This function may measure the difference between the rendered output (e.g., using current splat parameters) and an actual scene as depicted in the input image(s). For example, the function may measure a difference between a rendered image and input training images, wherein the rendered image is rendered using a splat rendering technique applied to a current set of splat parameters.

Through iterative processes, the system may adjust one or more parameters of each splat, such as the spherical harmonics coefficients for the splat, optimizing them to best represent the part of the scene they correspond to (e.g., using the input from operation 302 as a ground truth). This optimization may consider not only the color accuracy, but also how these colors should change with different viewing angles. The loss function may be used to determine which parameters of each splat are optimized during the iterative training process. In example embodiments, any number of splats may also be added or removed.

As the training progresses, the system may aggregate per-pixel data into per-splat data. This means that instead of handling individual pixels, the system may start to treat each splat as a representative of multiple pixels. This aggregation may be guided by the optimized spherical harmonics coefficients, which dictate how well the splats can approximate larger areas of the scene.

At operation 308, one or more post-processing operations may be performed. These operations may be integrated into or closely associated with the training phase. They may be useful for optimizing the system's output during the training itself.

For example, integrating material segmentation into the training process may be a beneficial addition to training. This could involve using material properties to guide the optimization of splat parameters, potentially improving the system's ability to accurately simulate different materials.

As another example, during training, continuous optimization of parameters, including those for material properties and/or directional opacity, may be performed. Such ongoing adjustments may ensure that the splats are accurately representing a 3D scene with respect to both geometry and material characteristics.

In example embodiments, the post-processing may include operations for implementing shared properties, as described with respect to FIG. 4.

In this way, the accuracy and effectiveness of the model during the development of the splat parameters may be improved, ensuring that the training output is of high quality and ready for further optimization in post-processing.

At operation 310, some or all of operations 302-308 may be repeated to improve upon or refine the model (e.g., splat parameters).

In example embodiments, one or more splat parameters, including any splat parameters described herein, are interdependent; therefore, they may be all optimized together at the same time using the described iteration approach. For example, position, rotation, YUV spherical harmonics, and/or opacity spherical harmonics may be a part of the same loss function. In alternative embodiments, a modular system may be implemented, where some parameters are trained after others may be used; however, such a modular system may result in lower final quality (e.g., because the parameters that were trained last would try to improve the value of the loss function at the expense of lowering the quality of previously trained parameters).

For example, regarding directional opacity, if optimization of the directional opacity parameters is actually performed after the main training, then splats would be simply already located in 3d positions where they cannot take much advantage of the directional opacity, as it was not considered in the preceding training module. As a result, the positive effect may be significantly mitigated. This problem can be resolved by performing training of all parameters identified as having importance in the final output at the same time.

Here, Y, U, V channels are used instead of R, G, B channels; therefore, the training is performed in a different color space, which results in different performance and quality. Specifically, training in YUV space can be faster (e.g., because number of spherical harmonics bands for UV channels can be reduced without much effect on the final approximation quality), and/or training can be more easily configured to favor different aspects of the color, as the loss for Y, U, V channels is computed independently and only then combined using a formula (e.g., using a linear combination of the per-channel loss which allows for the weighting of loss to favor either luminosity or chromaticity).

In example embodiments, the rasterized YUV splats may be compared against the YUV version of the one or more input images (e.g., when a splat is rasterized, its view direction becomes fixed and determined by the camera configuration of the input view; therefore, YUV spherical harmonics coefficients of each splat evaluate to scalar YUV values for a specific camera view); however, in computer code this color space conversion may be performed implicitly through coefficients of the loss function.

FIG. 4 is flowchart depicting an example method of implementing material property sharing in rendering.

At operation 402, geometry data and/or material data may be received. The received data may be in the form of optimized splats (e.g., splats output from a training as described with respect to FIG. 3). In example embodiments, geometry data may include one or more of positions, normals, and/or material properties of each splat. The geometry data may form a basic structure of a scene to be rendered.

In example embodiments, material data may include one or more of a color, a reflectivity, a texture, and/or other relevant attributes (e.g., that define how each splat interacts with light).

At operation 404, splats may be segmented by similar material properties. The material properties of splats may be analyzed (e.g., to group them into clusters with similar characteristics). This may be done using techniques such as k-means clustering or other statistical classification methods.

The segmentation may consider one or more factors like color, texture, opacity, and/or physical properties (e.g., to ensure that splats within the same segment share similar rendering behaviors).

At operation 406, one or more shared parameters may be defined. For example, for each segment of splats, shared parameters that best represent the common characteristics of the group may be calculated. This might include averaging values or using a representative splat's properties as a standard for an entire group. These parameters may be stored in a central repository that can be accessed during the rendering process.

At operation 408, one or more shared parameters may be applied to one or more splats. One or more shared parameters may be applied to each splat within the respective segments. This may ensure that all splats in a segment are rendered with consistent material properties, reducing the variability and enhancing the coherence of the visual output. Individual splat parameters may be adjusted slightly if necessary (e.g., to maintain unique details while still adhering to the overall material consistency).

At operation 410, data may be optimized for rendering. The material data may be compressed (e.g., by eliminating redundant information within each segment). Because splats may share parameters, there is no need to store individual material properties for each splat, significantly reducing the data footprint. The optimized data may be prepared for efficient processing in the rendering pipeline. In accordance with an embodiment, the shared data may be stored using a function rather than individual data for each splat. In example embodiments, segmentation may be performed using a neural network which encodes information about all the splats at the same time. For example, a positional encoding neural network may be used for segmentation, which takes the splat position as input, and produces the splat parameters as output. In example embodiments, a hybrid approach may be used where some splat parameters are computed by the neural network, and other parameters are stored per splat.

At operation 412, a scene is rendered. The processed data with shared properties may be used to render the scene. The rendering algorithm may take into account a uniformity within one or more segments (e.g., to produce a visually coherent image that accurately represents the scene's materials under various lighting conditions).

At operation 414, a final image is output. The rendered image may be displayed or stored, as needed. This may involve outputting to a display device, saving to a file, or transmitting over a network.

In example embodiments, one or more mechanisms to dynamically adjust shared parameters during runtime may be implemented (e.g., based on a scene's lighting or viewpoint changing significantly), ensuring that material properties remain realistic under different conditions.

In example embodiments, hardware acceleration, such as GPU computing, may be leveraged (e.g., to handle the data-intensive tasks of segmenting splats and applying shared parameters, especially in real-time applications).

In example embodiments, operations for quality control (e.g., to check the consistency and realism of rendered materials) may be performed. In example embodiments, robust error handling may be used (e.g., to manage potential issues during data segmentation and/or parameter application).

The ideas described herein may provide significant improvements for the visual quality and compression rates for an already existing technology. For example, rendering with Gaussian splatting techniques as described herein may be used for rendering on low end devices, but it is also a very efficient differential rendering method and may be used in various artificial intelligence (AI) applications which depend on differential rendering (e.g., where differential rendering allows the use of gradient-based optimization in neural network training and also enables inverse graphics problems where images can be used to infer or optimize 3D scene parameters that produced the images). Specifically, it can be used as a part of the neural rendering pipeline (e.g., the per-splat YUV representation may be used for 3D scene representation within the neural rendering pipeline and/or the Gaussian splat representation enables differentiation within the neural rendering pipeline).

A method of rendering one or more images is disclosed.

Camera data is received from a camera in a 3D environment (e.g., a scene). This may include camera position and orientation within the environment, and may include camera frustum data.

Per-splat YUV values are accessed from a trained splat model, wherein the per-splat YUV values are represented using spherical harmonics (e.g., to account for variations in viewing direction).

One or more YUV parameters of the per-splat YUV values are adjusted to optimize rendering based on one or more conditions, the one or more YUV parameters including one or more harmonics coefficients for each splat.

The object is rendered using the adjusted per-splat YUV values, wherein the rendering includes integrating the optimized per-splat YUV values with one or more rendering effects (e.g., lighting, shadows, and/or reflections) to produce a final visual output.

The final visual output may be converted to RGB data for compatibility with display technology. For example, the system may convert the trained YUV splats into RBG splats and then use those to go directly to RGB rendered images. With this variation, the conversion from YUV to RGB may happen before rasterization. The system may convert the corresponding spherical harmonics coefficients instead of the final color because the final color depends on the direction. The final color may be computed as a linear combination of the spherical harmonics coefficients and spherical function values. The conversion between YUV and RGB maybe a linear transformation; therefore. those can be swapped. With this variation, the system may separate clipping, which is normally performed during color conversion, and do this at the very end.

A method of training a model to generate per-splat YUV values from one or more RGB images disclosed.

The one or more images are received. In example embodiments, the one or more RGB images capture how one or more objects look from one or more specific points (e.g., from where one or more cameras are located).

In a preprocessing step, the one or more RGB images are converted to YUV images. In example embodiments, this conversion includes generating an initial approximate configuration of per-splat YUV values corresponding to the one or more images. In example embodiments, per-splat RGB values are estimated first and then converted to approximate per-splat YUV values.

In example embodiments, spherical harmonics are applied to the per-pixel YUV values to transform these values into a format suitable for per-splat representation, wherein the transformation facilitates the capture of color variations based on viewing direction.

A machine learning training algorithm is used to train a model that includes the transformed YUV values in the per-splat YUV representation, wherein the training includes optimizing splat parameters (e.g., spherical harmonics coefficients) to minimize a loss function that evaluates the difference between rendered outputs and actual scene appearances from the one or more received images; wherein the rendered outputs are rendered using the per-splat YUV representation.

In example embodiments, the machine learning model optimizes the approximate YUV splat parameters, including the YUV-splat color represented using spherical harmonics, so that the resulting splat parameter configuration can be used to render output images that match the input images more accurately.

In example embodiments, the per-splat YUV values are produced from the training algorithm, wherein the per-splat YUV values are configured to enhance rendering efficiency and visual quality in one or more subsequent rendering processes.

In example embodiments, the algorithm for reconstructing and/or rendering of an object is separated from the object, so that it can be used to reconstruct and/or render different objects, not a particular one. In this case, the algorithm itself stays the same during training, but the parameters selected to represent the object are learned and applied by the algorithm.

A method of implementing directional opacity handling in Gaussian splats is disclosed.

An approximate representation of a scene is received (e.g., including one or more images generated from one or more camera angles).

At a pre-processing step, 3D geometry data is generated (e.g., from a rendering engine configured to process graphics data for real-time applications), the 3D geometry data including approximate positions and sizes of splats.

Directional opacity values are calculated for each splat based on viewing angles relative to the splat's normal and the viewer's position, wherein the opacity values are determined using spherical harmonics. In example embodiments, initial approximate directional opacity parameters are learned and applied via a machine-learned model (e.g., like the YUV parameters described above).

In example embodiments, the calculated directional opacity values are applied to each splat to dynamically adjust visibility during rendering, wherein the adjustments allow splats to selectively and gradually hide or reveal themselves based on the viewer's perspective (e.g., to enhance the realism of rendered scenes).

One or more scenes are rendered using the splats with applied directional opacity values and a rendered image is output (e.g., to a display device or storage medium) (e.g., wherein the rendering process is optimized to maintain high visual fidelity and/or performance in varying viewing conditions).

A method of implementing splat property sharing in rendering is disclosed.

3D geometry data and/or associated material properties are received for each splat of a plurality of splats (e.g., from a rendering engine configured to process graphics data for interactive and real-time applications).

The plurality of splats is segmented into groups based on similarity in material properties using a clustering algorithm, wherein each group of splats shares one or more common characteristics (e.g., color, texture, opacity, and/or reflectivity) (e.g., to enhance rendering consistency and reduce computational load).

One or more shared parameters are applied to each group of splats, wherein the one or more shared parameters are calculated to represent an average or one or more representative material properties of the group (e.g., standardizing the appearance of splats within the same group and optimizing data storage and data processing for the group).

A scene is rendered or caused to be rendered using the splats with the applied one or more shared parameters, and a rendered image is output (e.g., to a display device or a storage medium), wherein the rendering process is optimized (e.g., to maintain high visual fidelity and/or performance while reducing the variability in material properties across similar objects).

While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

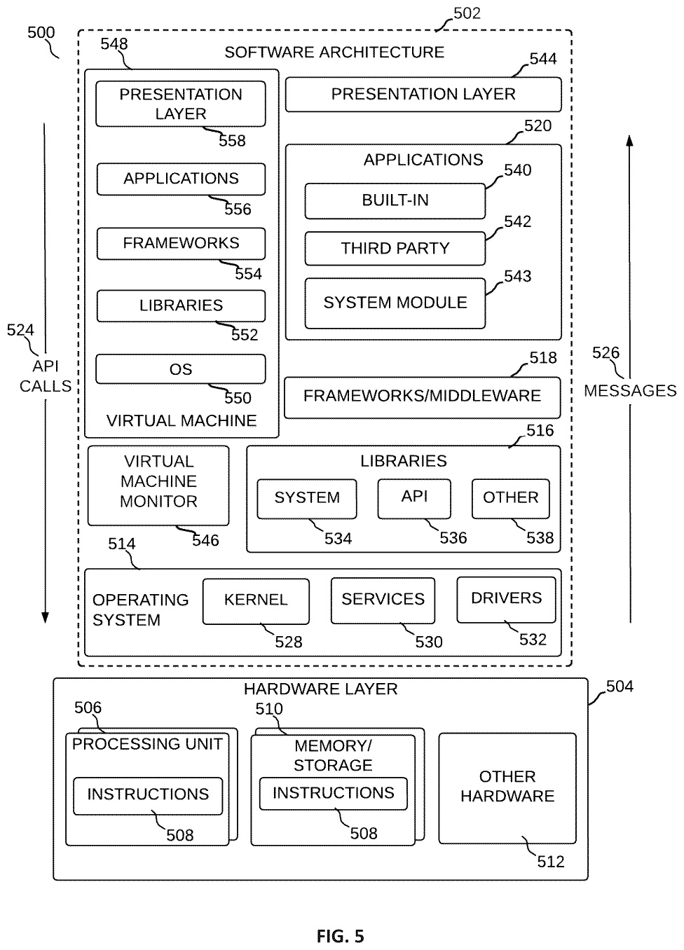

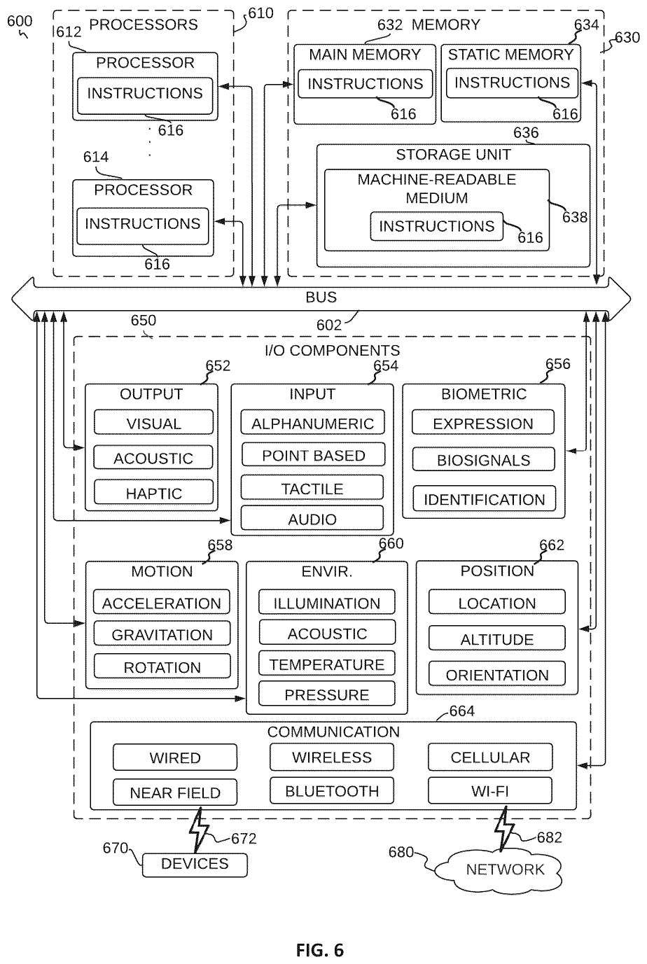

FIG. 5 is a block diagram 500 illustrating an example software architecture 502, which may be used in conjunction with various hardware architectures herein described to provide a gaming engine 501 and/or components of the rendering engine. FIG. 5 is a non-limiting example of a software architecture and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 1050. A representative hardware layer 504 is illustrated and can represent, for example, the machine 600 of FIG. 6. The representative hardware layer 504 includes a processing unit 506 having associated executable instructions 508. The executable instructions 508 represent the executable instructions of the software architecture 502, including implementation of the methods, modules and so forth described herein. The hardware layer 504 also includes memory/storage 510, which also includes the executable instructions 508. The hardware layer 504 may also comprise other hardware 512.

In the example architecture of FIG. 6, the software architecture 502 may be conceptualized as a stack of layers where each layer provides particular functionality. For example, the software architecture 502 may include layers such as an operating system 514, libraries 516, frameworks or middleware 518, applications 520 and a presentation layer 544. Operationally, the applications 520 and/or other components within the layers may invoke application programming interface (API) calls 524 through the software stack and receive a response as messages 526. The layers illustrated are representative in nature and not all software architectures have all layers. For example, some mobile or special purpose operating systems may not provide the frameworks/middleware 518, while others may provide such a layer. Other software architectures may include additional or different layers.

The operating system 514 may manage hardware resources and provide common services. The operating system 514 may include, for example, a kernel 528, services 530, and drivers 532. The kernel 528 may act as an abstraction layer between the hardware and the other software layers. For example, the kernel 528 may be responsible for memory management, processor management (e.g., scheduling), component management, networking, security settings, and so on. The services 530 may provide other common services for the other software layers. The drivers 532 may be responsible for controlling or interfacing with the underlying hardware. For instance, the drivers 532 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 516 may provide a common infrastructure that may be used by the applications 520 and/or other components and/or layers. The libraries 516 typically provide functionality that allows other software modules to perform tasks in an easier fashion than to interface directly with the underlying operating system 514 functionality (e.g., kernel 528, services 530 and/or drivers 532). The libraries 616 may include system libraries 534 (e.g., C standard library) that may provide functions such as memory allocation functions, string manipulation functions, mathematic functions, and the like. In addition, the libraries 516 may include API libraries 536 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 516 may also include a wide variety of other libraries 538 to provide many other APIs to the applications 520 and other software components/modules.

The frameworks 518 (also sometimes referred to as middleware) provide a higher-level common infrastructure that may be used by the applications 520 and/or other software components/modules. For example, the frameworks/middleware 518 may provide various graphic user interface (GUI) functions, high-level resource management, high-level location services, and so forth. The frameworks/middleware 518 may provide a broad spectrum of other APIs that may be utilized by the applications 520 and/or other software components/modules, some of which may be specific to a particular operating system or platform.

The applications 520 include built-in applications 540 and/or third-party applications 542. Examples of representative built-in applications 540 may include, but are not limited to, a contacts application, a browser application, a book reader application, a location application, a media application, a messaging application, and/or a game application. Third-party applications 542 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 542 may invoke the API calls 524 provided by the mobile operating system such as operating system 514 to facilitate functionality described herein. In example embodiments, the applications 520 may one or more system module(s) 543. In example embodiments, any of the operations described herein, such as the operations described with respect to FIGS. 1-4, may be implemented by the rendering module 543. In example embodiments, the applications 520 may include one or more of the modules depicted in FIG. 1.

The applications 520 may use built-in operating system functions (e.g., kernel 528, services 530 and/or drivers 532), libraries 516, or frameworks/middleware 518 to create user interfaces to interact with users of the system. Alternatively, or additionally, in some systems, interactions with a user may occur through a presentation layer, such as the presentation layer 544. In these systems, the application/module “logic” can be separated from the aspects of the application/module that interact with a user.

Some software architectures use virtual machines. In the example of FIG. 5, this is illustrated by a virtual machine 548. The virtual machine 548 creates a software environment where applications/modules can execute as if they were executing on a hardware machine (such as the machine 600 of FIG. 6, for example). The virtual machine 548 is hosted by a host operating system (e.g., operating system 514) and typically, although not always, has a virtual machine monitor 546, which manages the operation of the virtual machine 548 as well as the interface with the host operating system (i.e., operating system 514). A software architecture executes within the virtual machine 548 such as an operating system (OS) 550, libraries 552, frameworks 554, applications 556, and/or a presentation layer 558. These layers of software architecture executing within the virtual machine 548 can be the same as corresponding layers previously described or may be different.

FIG. 6 is a block diagram illustrating components of a machine 600, according to some example embodiments, configured to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. As such, the instructions 616 may be used to implement modules or components described herein. The instructions transform the general, non-programmed machine into a particular machine programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines that individually or jointly execute the instructions 616 to perform any one or more of the methodologies discussed herein.

The machine 600 may include processors 610, memory 630, and input/output (I/O) components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 612 and a processor 614 that may execute the instructions 616. The term “processor” is intended to include multi-core processor that may comprise two or more independent processors (sometimes referred to as “cores”) that may execute instructions contemporaneously. Although FIG. 6 shows multiple processors, the machine 600 may include a single processor with a single core, a single processor with multiple cores (e.g., a multi-core processor), multiple processors with a single core, multiple processors with multiples cores, or any combination thereof.

The memory/storage 630 may include a memory, such as a main memory 632, a static memory 634, or other memory, and a storage unit 636, both accessible to the processors 610 such as via the bus 602. The storage unit 636 and memory 632, 634 store the instructions 616 embodying any one or more of the methodologies or functions described herein. The instructions 616 may also reside, completely or partially, within the memory 632, 634, within the storage unit 636, within at least one of the processors 610 (e.g., within the processor's cache memory), or any suitable combination thereof, during execution thereof by the machine 600. Accordingly, the memory 632, 634, the storage unit 636, and the memory of processors 610 are examples of machine-readable media 638.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine 600 (e.g., processors 610), cause the machine 600 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 650 may include a wide variety of components to receive input, provide output, produce output, transmit information, exchange information, capture measurements, and so on. The specific input/output (I/O) components 650 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 650 may include many other components that are not shown in FIG. 6. The input/output (I/O) components 650 are grouped according to functionality merely for simplifying the following discussion and the grouping is in no way limiting. In various example embodiments, the input/output (I/O) components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 650 may include communication components 664 operable to couple the machine 600 to a network 680 or devices 670 via a coupling 682 and a coupling 672 respectively. For example, the communication components 664 may include a network interface component or other suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 662, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

The term ‘content’ used throughout the description herein should be understood to include all forms of media content items, including images, videos, audio, text, 3D models (e.g., including textures, materials, meshes, and more), animations, vector graphics, and the like.

The term ‘game’ used throughout the description herein should be understood to include video games and applications that execute and present video games on a device, and applications that execute and present simulations on a device. The term ‘game’ should also be understood to include programming code (either source code or executable binary code) which is used to create and execute the game on a device.

The term ‘environment’ used throughout the description herein should be understood to include 2D digital environments (e.g., 2D video game environments, 2D simulation environments, 2D content creation environments, and the like), 3D digital environments (e.g., 3D game environments, 3D simulation environments, 3D content creation environments, virtual reality environments, and the like), and augmented reality environments that include both a digital (e.g., virtual) component and a real-world component.

The term ‘digital object’, used throughout the description herein is understood to include any object of digital nature, digital structure or digital element within an environment. A digital object can represent (e.g., in a corresponding data structure) almost anything within the environment; including 3D models (e.g., characters, weapons, scene elements (e.g., buildings, trees, cars, treasures, and the like)) with 3D model textures, backgrounds (e.g., terrain, sky, and the like), lights, cameras, effects (e.g., sound and visual), animation, and more. The term ‘digital object’ may also be understood to include linked groups of individual digital objects. A digital object is associated with data that describes properties and behavior for the object.

The terms ‘asset’, ‘game asset’, and ‘digital asset’, used throughout the description herein are understood to include any data that can be used to describe a digital object or can be used to describe an aspect of a digital project (e.g., including: a game, a film, a software application). For example, an asset can include data for an image, a 3D model (textures, rigging, and the like), a group of 3D models (e.g., an entire scene), an audio sound, a video, animation, a 3D mesh and the like. The data describing an asset may be stored within a file, or may be contained within a collection of files, or may be compressed and stored in one file (e.g., a compressed file), or may be stored within a memory. The data describing an asset can be used to instantiate one or more digital objects within a game at runtime (e.g., during execution of the game).

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

I/We claim:

1. A non-transitory computer-readable storage medium storing a set of instructions that, when executed by one or more computer processors, causes the one or more computer processors to perform operations, the operations comprising:
receiving a representation of a scene;
generating a set of splats to represent the scene;
estimating splat parameters for each splat in the set of splats in the scene;
applying a machine-learning model trained to refine values of the estimated splat parameters, the values including directional opacity values; and
providing the refined values as an output usable to enhance subsequent processing of the set of splats.

2. The non-transitory computer-readable storage medium of claim 1, the operations further comprising using the output to render each splat in the set of splats, the rendering including using the refined directional opacity values to render an opacity of the splat according to a view of the scene.

3. The non-transitory computer-readable storage medium of claim 1, wherein the directional opacity values are represented using spherical harmonics to modulate an opacity of each splat based on a viewing angle of a viewer.

4. The non-transitory computer-readable storage medium of claim 1, wherein the machine-learning model is trained by iteratively adjusting spherical harmonics coefficients to minimize a loss function that measures a difference between rendered outputs and actual scene appearances.

5. The non-transitory computer-readable storage medium of claim 1, wherein the operations further comprise converting RGB color data to YUV color space for each splat, wherein the YUV color space separates luminance information from chrominance information.

6. The non-transitory computer-readable storage medium of claim 1, wherein the operations further comprise segmenting the set of splats into groups based on similarity in material properties and applying shared parameters to each group.

7. The non-transitory computer-readable storage medium of claim 1, wherein the operations further comprise performing post-processing operations including quantization of the splat parameters and filtering of the set of splats based on a visual contribution of each splat.

8. A system comprising:
one or more computer processors;
one or more computer memories;
a set of instructions stored in the one or more computer memories, the set of instructions configuring the one or more computer processors to perform operations, the operations comprising:
receiving a representation of a scene;
generating a set of splats to represent the scene;
estimating splat parameters for each splat in the set of splats in the scene;
applying a machine-learning model trained to refine values of the estimated splat parameters, the values including directional opacity values; and
providing the refined values as an output usable to enhance subsequent processing of the set of splats.

9. The system of claim 8, the operations further comprising using the output to render each splat in the set of splats, the rendering including using the refined directional opacity values to render an opacity of the splat according to a view of the scene.

10. The system of claim 8, wherein the directional opacity values are represented using spherical harmonics to modulate an opacity of each splat based on a viewing angle of a viewer.

11. The system of claim 8, wherein the machine-learning model is trained by iteratively adjusting spherical harmonics coefficients to minimize a loss function that measures a difference between rendered outputs and actual scene appearances.

12. The system of claim 8, wherein the operations further comprise converting RGB color data to YUV color space for each splat, wherein the YUV color space separates luminance information from chrominance information.

13. The system of claim 8, wherein the operations further comprise segmenting the set of splats into groups based on similarity in material properties and applying shared parameters to each group.

14. The system of claim 8, wherein the operations further comprise performing post-processing operations including quantization of the splat parameters and filtering of the set of splats based on a visual contribution of each splat.

15. A method comprising:
receiving an approximate representation of a scene;
receiving a representation of a scene;
generating a set of splats to represent the scene;
estimating splat parameters for each splat in the set of splats in the scene;
applying a machine-learning model trained to refine values of the estimated splat parameters, the values including directional opacity values; and
providing the refined values as an output usable to enhance subsequent processing of the set of splats.

16. The method of claim 15, further comprising using the output to render each splat in the set of splats, the rendering including using the refined directional opacity values to render an opacity of the splat according to a view of the scene.

17. The method of claim 15, wherein the directional opacity values are represented using spherical harmonics to modulate an opacity of each splat based on a viewing angle of a viewer.

18. The method of claim 15, wherein the machine-learning model is trained by iteratively adjusting spherical harmonics coefficients to minimize a loss function that measures a difference between rendered outputs and actual scene appearances.

19. The method of claim 15, further comprising converting RGB color data to YUV color space for each splat, wherein the YUV color space separates luminance information from chrominance information.

20. The method of claim 15, further comprising segmenting the set of splats into groups based on similarity in material properties and applying shared parameters to each group.
